(19) United States
(12) Patent Application Publication
(10) Pub. No.: US 2014/0089219 A1
(43) Pub. Date: Mar. 27, 2014

(54) A SYSTEM AND METHOD THAT PROVIDES PERSONAL, EDUCATIONAL AND CAREER NAVIGATION, VALIDATION, AND ANALYSIS TO USERS

(71) Applicant: LONE STAR COLLEGE, Houston, TX (US)

(72) Inventor: Michael L. Mathews, Houston, TX (US)

(73) Assignee: Lone Star College, Houston, TX (US)

(21) Appl. No.: 13/840,507

(22) Filed: Mar. 15, 2013

Related U.S. Application Data
(60) Provisional application No. 61/705,542, filed on Sep. 25, 2012.

(51) Int. Cl. G06Q 50/20; G06Q 10/10

(52) U.S. Cl. CPC G06Q 50/2053; G06Q 10/10
USPC 705/327

(57) ABSTRACT

Methods and systems that provide personal, educational, and career analytics for students to navigate the ever increasing educational and career landscape. Instant simulated journeys of success may be created by translating personal, educational, and career data into visual and navigational choices for every student and parent. Users may be allowed instant access to all K1-to-K20 personalized education records in order to continually analyze that data against the labor market, labor data, personal interests, and educational choices and job forecasts in order to produce continual options and validation. Results may be produced that help students and parents more accurately prepare and plan by visually seeing progress, strengths, weaknesses, funding needs, options and statistics on a regular basis.

### CROSS REFERENCE TO RELATED APPLICATIONS

This application claims priority to U.S. Provisional Patent Application Ser. No. 61/705,542 filed Sep. 25, 2012, entitled “SYSTEM AND METHOD THAT PROVIDES PERSONAL, EDUCATIONAL AND CAREER ANALYSIS TO STUDENTS,” which is hereby incorporated herein by reference in its entirety.

### FIELD

Various embodiments may be generally directed to interfacing with users over a network. Some embodiments may be particularly directed to methods, systems, and media for interfacing with users over a network.

### BACKGROUND

Over 2,000,000 jobs every year go unfilled partially or mostly due to lack of skilled workers. The inability to guide students and parents through the maze of educational choices cost families, states, and government billions of dollars annually. The evidence is seen in the percentage of students who do not graduate, complete, or get placed in a job. Therefore there exists a need for students and parents to assess choices and pathways through education to a job and career in a systematic and navigational manner. The current educational systems are designed, developed, and licensed to colleges, universities and k12 schools. Indeed, almost all current educational systems are designed, manufactured, sold, and licensed to educational institutions versus the actual owners of the system data: students. This has prevented students and parents from owning, accessing, collecting and aggregating their educational records across the educational institutions that they have attended. This failure to collect, access, and aggregate their personal data makes it difficult if not impossible for students and parents to set and align clear pathways toward further education and/or a career.

The U.S. Department of Education Open Data Initiative is a recently announced program that promises to harness the power of open data from the U.S. Department of Education and other sources. This initiative will help consumers make more informed decisions on potential education-to-career pathways and choices based on owning and accessing their personal data that illuminates their learning outcomes. The launch of education.data.gov is intended to unlock the power of education data to make it accessible and useful for all U.S based students. This web site serves as a central guide for education data resources including high-value data sets, data visualization tools, resources for the classroom, applications created from open data and more. These datasets have been gathered from various agencies to provide detailed information on the state of education on all levels, from cradle-to-career and beyond. Since alignment and pathways for students to obtain careers and jobs via education have become so comprehensive, there exists a need for students and parents to assess choices and pathways through education to a job and career. More specifically, a positioning and tracking capability is needed in order to navigate the possible choices, and lay-out a plan for a specific journey toward a promising job and career.

### SUMMARY

The present invention relates to methods and systems that provide personal, educational, and career analytics for every user, which may be students, parents, or any other type of user, to simulate, navigate, validate, and plan a personal journey through the educational and career landscape(s). Further, the invention creates instant simulated journeys of success by translating personal, education, and career data into visual and navigational choices for every student and parent. The present invention differs from what currently exists because it is designed and developed for students and parents as opposed to educational institutions. The present invention can be purchased by any individual, whereas most other educational solutions must be assigned through the school the student attends. More specifically, the present invention collects and aggregates the life-long educational records of all job applicants and leverages the Education Data Initiative to allow students to carry and own their educational records in order to continually position and navigate their education-to-career journey in a graphic manner. The present invention is personalized and adaptive to the individual learner needs, in order to provide pathways and routes to maximize student success. For example, the present invention allows instant access to all K1-to-K20 personalized education records in order to continually analyze that data against the labor market, labor data, personal interests, and educational choices and job forecasts in order to produce continual options and validation. The present invention produces the results that help students and parents more accurately prepare and plan by visually seeing progress, strengths, weaknesses, funding needs, options and statistics on a regular basis.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts an exemplary educational and career positioning system in accordance with one or more embodiments.

FIG. 2 depicts an exemplary block diagram of an educational and career positioning system in accordance with one or more embodiments.

FIG. 3 depicts an exemplary block diagram of a network having a front-end system and a back-end system in accordance with one or more embodiments.

FIG. 4 depicts an exemplary logic flow in accordance with one or more embodiments.

FIG. 5 depicts an exemplary application flow in accordance with one or more embodiments.

FIG. 6 depicts an exemplary workflow using the system in accordance with one or more embodiments.

FIG. 7 depicts an exemplary application framework in which functions of the application may be broken across.

FIG. 8 depicts an exemplary user interface for presenting access to the different functions of the application in accordance with one or more embodiments.

FIGS. 9A-9J depict exemplary user interfaces for providing access to a user to an educational and career positioning system.

FIG. 10 depicts exemplary application inputs and outputs in accordance with one or more embodiments.

FIG. 11 depicts an exemplary EDUFAX report in accordance with one or more embodiments.

FIG. 12 depicts an exemplary EDUFAX report in accordance with one or more embodiments.

FIG. 13 depicts an exemplary EDUFAX report in accordance with one or more embodiments.

FIG. 14 depicts an exemplary educational and career positioning system in accordance with one or more embodiments.

### DETAILED DESCRIPTION OF THE DRAWINGS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

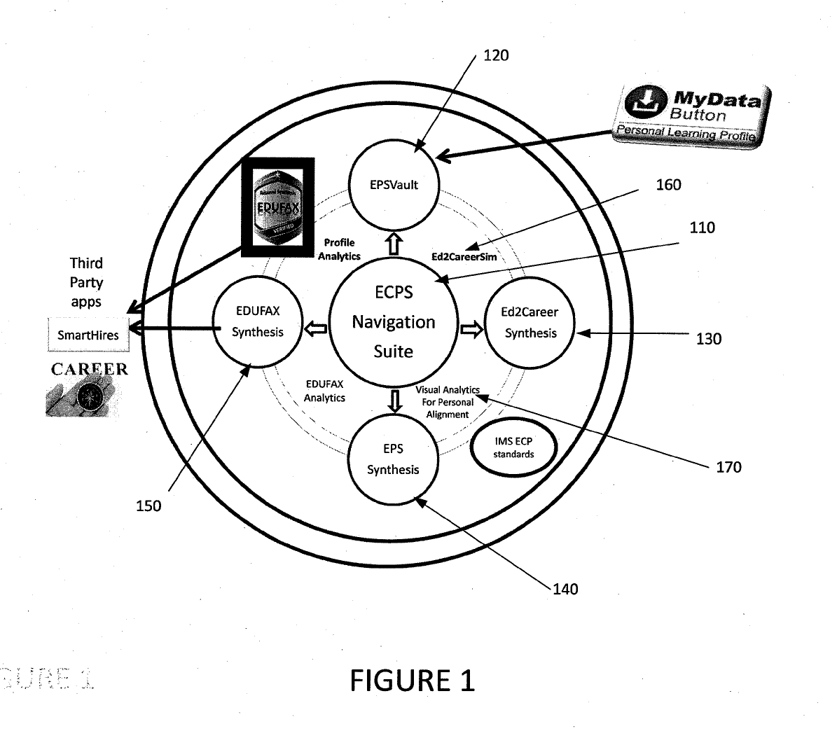

FIG. 1 depicts an exemplary educational and career positioning system (ECPS) 100 in accordance with one or more embodiments. System 100 may include educational and career positioning (ECPS) navigation suite 110, EPS vault 120, Ed2Career synthesis 130, EPS Synthesis 140, EDUFAX resume synthesis 150, Ed2CareerSim 160, and visual analytics for personal alignment 170, each of which may a module implemented by any combination of software and/or hardware.

The ECPS may leverage technologies, methods, and personalized analytical processing to reduce the most common educational mistakes (taking wrong turns, running out of academic gas, miscalculating the distance, underestimating the costs, and not having a “norm” to compare a personalized educational journey against). ECPS may allow institutions to track students, and gives ownership as well as access to the very consumers of education—students. The ECPS may leverage the Department of Education's open data initiative which is not utilized in the systems or applications presently sold to educational institutions. In addition to an application software, the ECPS can be embodied in a stand-alone device that students and parents could use to run education and job simulations as well as produce stand-alone verification reports of a job applicants qualifications against job requirements.

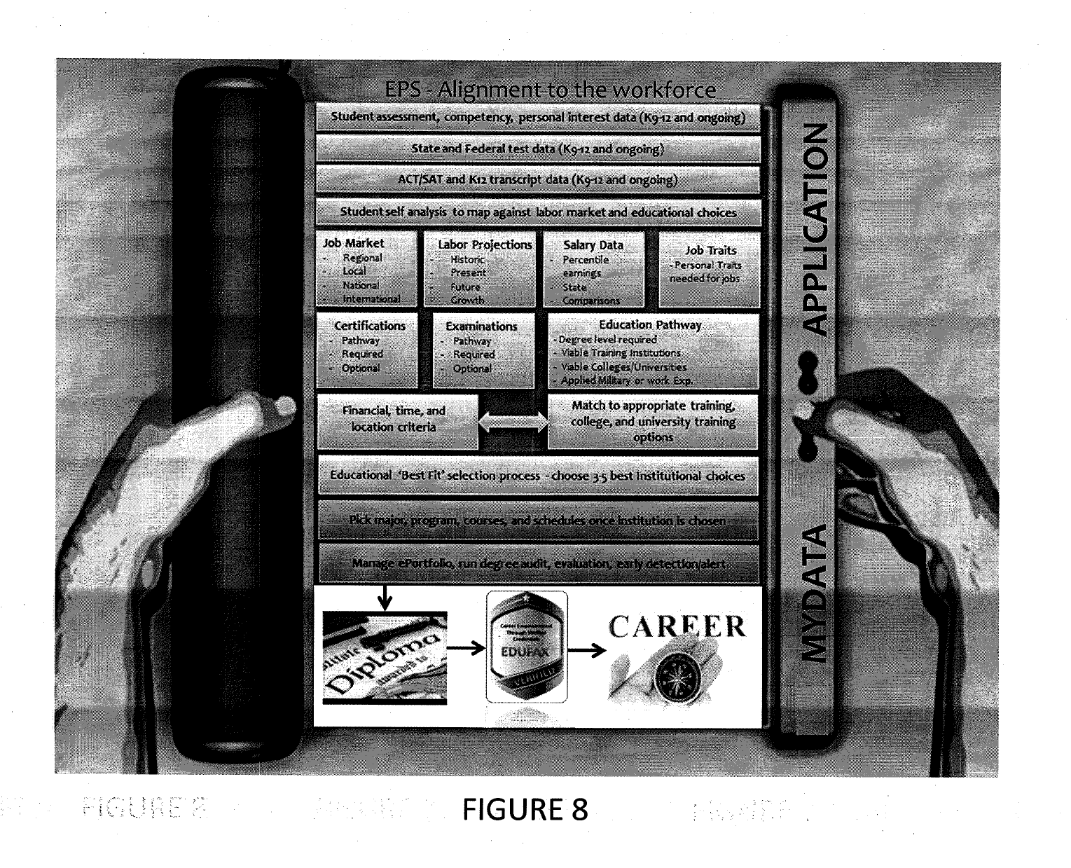

Navigation suite 110 may provide one or more interfaces to users to connect and utilize the various modules connected thereto. Navigation suite may be connected to EPS vault 120, Ed2Career synthesis 130, EPS Synthesis 140, EDUFAX resume synthesis 150, and any combination thereof. Exemplary embodiments of interfaces provided by navigation suite 110 include those depicted in FIGS. 8, 9, 11, 12, and 13.

EPS vault 120 may be a module that stores all student records. EPS vault 120 may follow the MyData button and/or open data initiative specifications. EPS value 120 may execute code to analyze data at the personal level. The MyData button initiative specification may refer to a specification that allows secure and confidential data pulls from sources of student information at a personal level across education systems. One implementation of the specification is available at http://www.ed.gov/edblogs/technology/files/2012/05/MyDataOpenDataSpecificationv1.3.pdf, the contents of which are hereby incorporated herein by reference in their entirety. EPS vault 120 may also incorporate standards agreed upon by the two national education standards committees. EPS vault 120 may also employ security algorithms for accessing individual records from governmental systems that store individual student data records.

Ed2Career synthesis 130 may simulate and/or synthesize the one, more, or all personal records of a student into career and/or job choices. Ed2Career synthesis 130 may aggregate all labor, required skills, career pathways, and badging information. Ed2Career synthesis 130 may execute UPI ed2careersim system software.

EPS Synthesis 140 may simulate and/or synthesize one, more, or all personal records of a student into education and training choices and options. EPS Synthesis 140 may aggregate all the public and private education, training, and credentialing options available. In some embodiments, EPS Synthesis 140 may execute UPI Visual Analytics for Personalized Performance software.

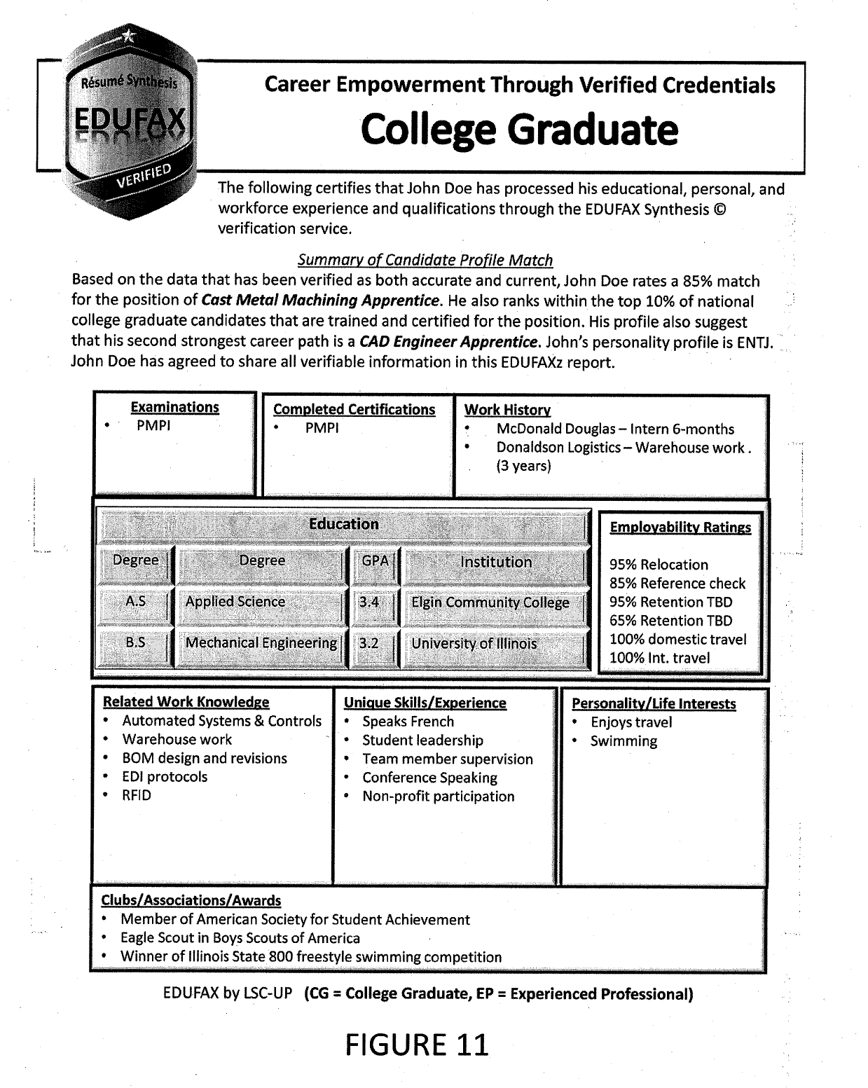

Resume synthesis 150 may synthesize one, more, or all of an individual's records, competencies, badges, experience, education, and/or training into a resume, e.g. an EDUFAX brand resume. Resume synthesis 150 may leverage the components found on modern resumes, yet assimilate the components into a format more suitable for employers. Exemplary formats are depicted in FIGS. 11, 12, and 13.

Ed2CareerSim 160 may be a module that processes the complete educational cycle of a student, potentially at every grade level on through the student's career options. Ed2CareerSim 160 may pass data between the modules of system 100 and the MyData Button.

Visual analytics for personal alignment 170 may refer to a reporting analytics engine that provides a person with graphical choices. The graphical choices may be any of those provided to one or more users as further described herein. The graphical choices may be presented using any of the user interfaces or via any of the computing devices described herein.

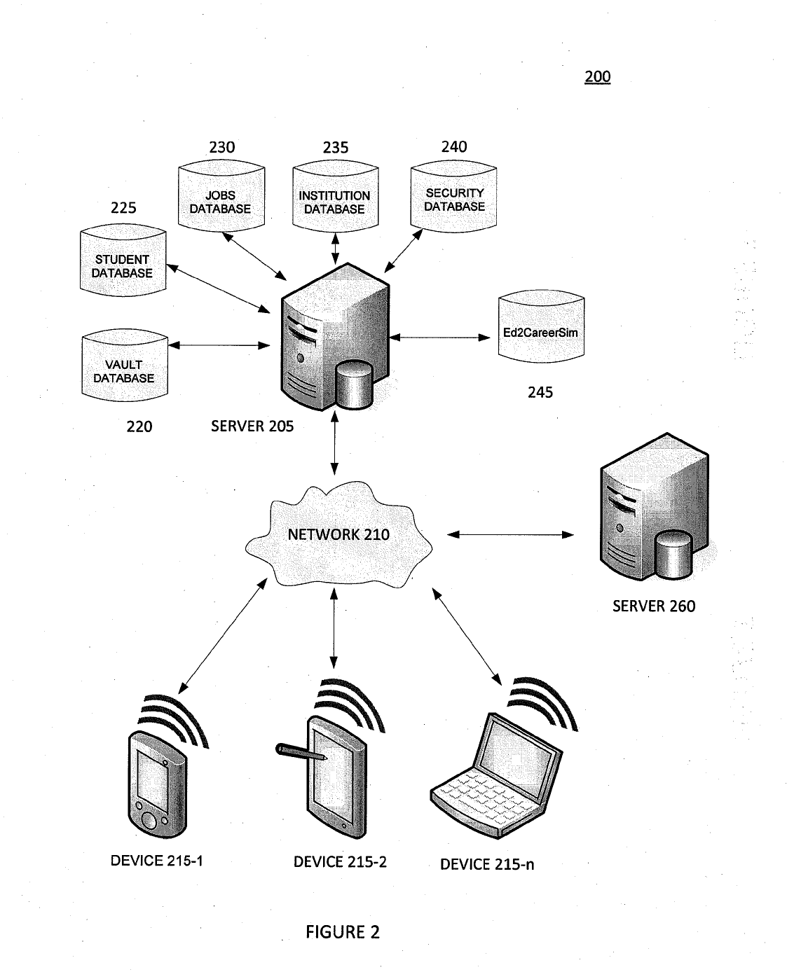

FIG. 2 depicts an exemplary educational and career positioning system 200 in accordance with one or more embodiments. In one embodiment, users of devices 215-1 through 215-n may register within a particular educational and career positioning system or institution and may connect to a network 210 (e.g. the Internet). Each of devices 215-1 through 215-n may be any type of computing device, including but not limited to a computer, workstation, mobile device, a PDA, an iPad, or a laptop computer. Server 205 may be maintained by the educational and career positioning service provider or a third party vendor. Educational and career positioning system 200 may also include a server 260. Server 260 may include any combination of features of server 205. Server 260 may also be connected to the other parts of education system 200 through network 210. Server 260 may be located on the same network as server 205 or on a different network as server 205. Server 260 may run or operate other instances the software used to provide the online educational and career positioning system. Server 260 may be run or operated by other institutions, either foreign or domestic. Server 260 may be run or operated by the same institution but in separate locations, either foreign or domestic. Educational and career positioning system 200 may include any number of additional servers, user devices, or network connections.

Server 205 may be connected to or include a number of databases, including a vault database 220, a student database 225, a jobs database 230, an institution database 235, a security database 240, Ed2CareerSim database 245, or any combination thereof. The vault database 220 may store student records. Vault database 220 may store information from the MyData button and/or consistent with the open data initiative specifications. Vault database 220 may be managed by or used in conjunction with EPS vault 120. Vault database may store information retrieved from other databases, including but not limited to databases 225-240. For example, any information retrieved from student database 225, jobs database 230, institution database 235, and/or security 240 may be stored in vault database 220 by EPS vault 120.

Student database 225 may store any information about students using the system. Student database 225 may store an inventory of all users that are affiliated with the particular learning program or institution. In one embodiment, such users are associated with network address, e.g., IP addresses, that may be stored in a user's profile. Student database 225 may store information about the students' names, class year, programs of study, locations, addresses, information about the student entered by the students, activities and interests of the students, education of the students, work experiences of the students, pictures of the users, job goals, data records, test information, self-entered education and job goals, other individual or personal growth data, or any combination thereof. Student database 225 may also store information about student progress in a course, information about courses the students have completed, activities the students have completed, examples of work products the students have completed, grades, evaluations, rankings, or any combination thereof

Jobs database 230 may store job information and/or job market information. Job market information may include local, regional, national, and international information; labor projections, including historic, present, future, and growth; salary data including percentile earnings, by state, and comparisons; and job traits, including one or more personal traits needed for jobs.

Institution database 235 may store information about programs offered by institutions and related data. For example, institution database 325 may store information relating to courses, programs, and/or degrees offered by an institution, course names, course identifiers, course numbers, course descriptions, course teachers, course teaching assistants, course schedules, course enrollment including students enrolled in the courses, past course offerings, future course offerings, number of users allowed to enroll in a course, course structure, course prerequisites, or any combination thereof. Institution database 235 may also store costs, fees, and expenses associated with any of the courses, programs, and/or degrees offered by an institution

Security database 240 may store security information for the system. Security information may include usernames of the users, passwords of the users, security questions used for verifying the identity of the users, answers to security questions, which parts of the system the users are able to access, or any combination thereof.

Ed2CareerSim database 245 may include at database structure to implement one or more of the following data tables: a data table for all the data fields to store all individual records from each grade, test, assessment, and personal accomplishment; a data table that stores all bureau of labor statistics from city, state, region, and national; a data table that stores all industry skills requirements; and a dynamic data table that stores all college degree, certifications, and diplomas required for job categories.

System 200 may also implement online analytic processing (OLAP) micro-data marts to allow individuals to perform data analytics against their personal records as well as matched against the larger data set. The OLAP micro marts are deployed as Visual Personalized Analytical Processing (VPAP) Online Analytical Processing is a category of software tools that provides analysis of data stored in a database. OLAP tools enable users to analyze different dimensions of multidimensional data. For example, it provides time series and trend analysis views. OLAP often is used in data mining. The chief component of OLAP is the OLAP server, which sits between a client and a database management systems (DBMS). The OLAP server understands how data is organized in the database and has special functions for analyzing the data. There are OLAP servers available for nearly all the major database systems. Server 205 may be an OLAP server, and one or more of the databases connected to server 205 may be used to implement the OLAP micro marts. Server 260 may be an OLAP server. The OLAP toolset may synthesize a report of all collected data, experience, accomplishments into an EDUFAX report-out that accompanies the resumes when individuals apply for jobs.

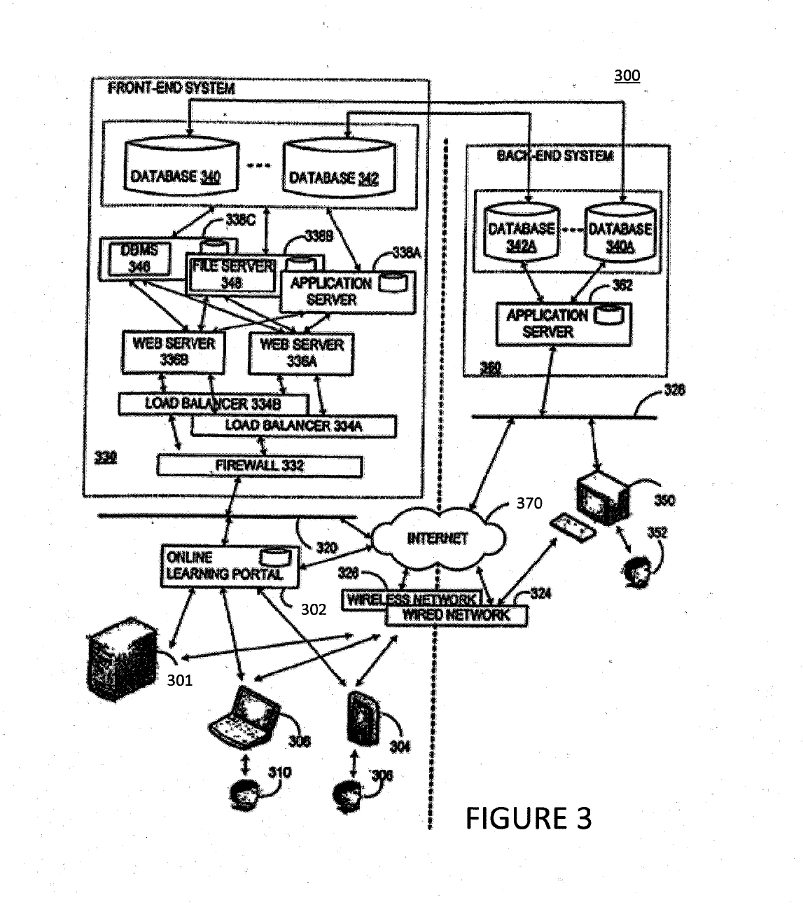

FIG. 3 depicts an exemplary block diagram 300 of a network having a front-end system and a back-end system in accordance with one or more embodiments. The front-end system 330 includes a firewall 332, which is coupled to one or more load balancers 334a, 334b. Load balancers 334a-b are in turn coupled to one or more web servers 336a-b. To provide the educational and career positioning system, the web servers 336a-b are coupled to one or more application servers 338a-c, each of which includes and/or accesses one or more front-end databases 340, 342, which may be central or distributed databases. The application servers serve various modules used for interaction between the different users and the learning system, including but not limited to educational and career positioning (ECPS) navigation suite 110, EPS vault 120, Ed2Career synthesis 130, EPS Synthesis 140, EDUFAX resume synthesis 150, Ed2CareerSim 160, and visual analytics for personal alignment 170, or any combination thereof. These modules may be run independently of each other.

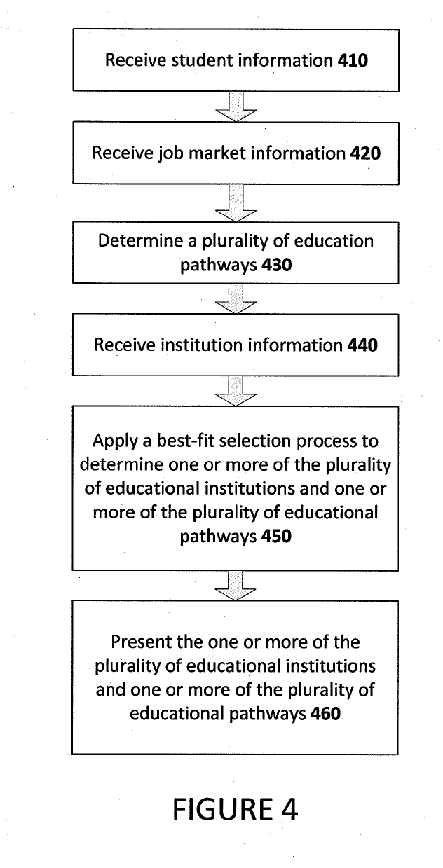

Web servers 336a-b provide various user portals, including student, teacher, and institution portals. The user portals may include various web interfaces. The servers 336a-b are coupled to load balancers 334a-b, which perform load balancing functions for providing optimum online session performance by transferring client user requests to one or more of the application servers 338ac according to a series of semantics and/or rules. The application servers 338a-c may include a database management system (DBMS) 346 and/or a file server 348, which manage access to one or more databases 340, 342. In the exemplary embodiment depicted in FIG. 4, the application servers 338a and/or 338b provide educational and career positioning content to the users 306, 310 which include electronic interfaces, progress reports, student profiles, career paths, as well as institutional content correlated with a course, school, institution, as processed by the server. Some of the content is generated via code stored either on the application servers 338a and/or 338b, while some other information and content, such as institutional information, may be retrieved along with the necessary data from the databases 340, 342 via application server 338c. The application server 338b may also provide users 306, 306 access to executable files which can be downloaded and installed on user devices 304, 310 for creating an appropriate learning environments and sessions, with branding and or marketing features that are tailored for a particular application, client or customer.

The central or distributed database 340, 342, stores, among other things, the web content and material deliverable to the users. The central or distributed database 340, 342, may store information stored in vault database 220, a student database 225, a jobs database 230, an institution database 235, a security database 240, or any combination thereof. The central or distributed database 340, 342 may also store retrievable information relating to or associated with students, teachers, responsible authorities, parents, learning centers, profiles (student, facilitator, teacher, faculty, course developer, assessor, etc.), billing information, schedules, statistical data, attendance data, enrollment data, teacher attributes, student attributes, historical data, demographic data, compliance data, certification data, billing rules, third party contract rules, educational district requirements, etc. Any or all of the foregoing data can be processed and associated as necessary for achieving a desired learning objective or a business objective associated with operating the system of the disclosed embodiments.

Updated program code and data are transferred from the back-end system 360 to the front-end system 330 to synchronize data between databases 340, 342 of the front-end system and databases 340a, 342a of the back-end system. Further, web servers 336a, 336b, which may be coupled to application servers 338a-c, may also be updated periodically via the same process. The back-end system 360 interfaces with a user device 350 such as a workstation, enabling interactive access for a system user 352, who may be, for example, a developer or a system administrator. The workstation 350 may be coupled to the back-end system 360 via a local network 328. Alternatively, the workstation 350 may be coupled to the back-end system 360 via the Internet 370 through the wired network 324 and/or the wireless network 326.

The back-end system 360 includes an application server 362, which may also include a file server or a database management system (DBMS). The application server 362 allows a user 352 to develop or modify application code or update other data, e.g., electronic content and electronic instructional material, in databases 340a, 342a. According to one embodiment, interactive client-side applications on the internet execute on a variety of internet delivery devices such as a web-browser, smart phones, and tablet devices such as the iPad, to provide an improved core student experience.

FIG. 4 depicts an exemplary logic flow in accordance with one or more embodiments.

In block 410, student information may be received. Student information may be stored in student database 225 or vault database 220. Student information may include student assessment, competency, and personal interest data, which may include data from any grades, including K9-12 and ongoing. Student information may include state and federal test data, which may include data from any grades, including K9-12 and ongoing. Student information may include ACT, SAT, other standardized testing data, and K12 transcript data, which may include data from any grades, including K9-12 and ongoing. Student information may be received from the student via a user interface provided by educational and career positioning system and/or may be received from any of source of student information, including those discussed herein.

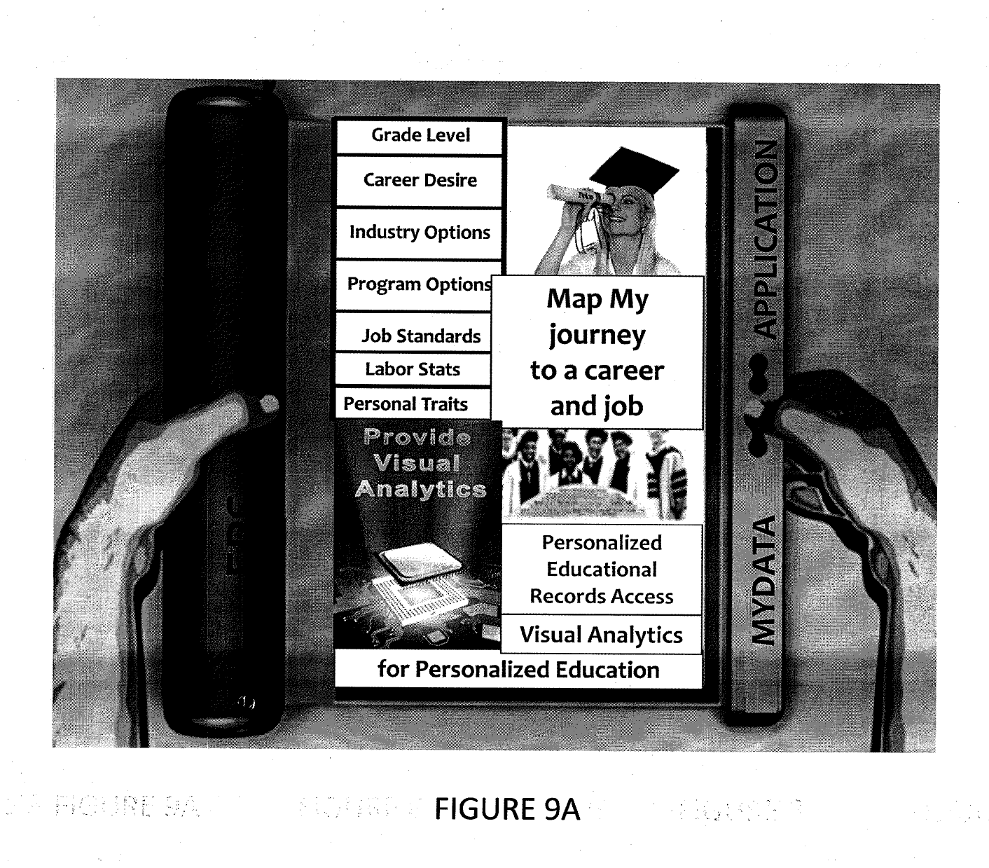

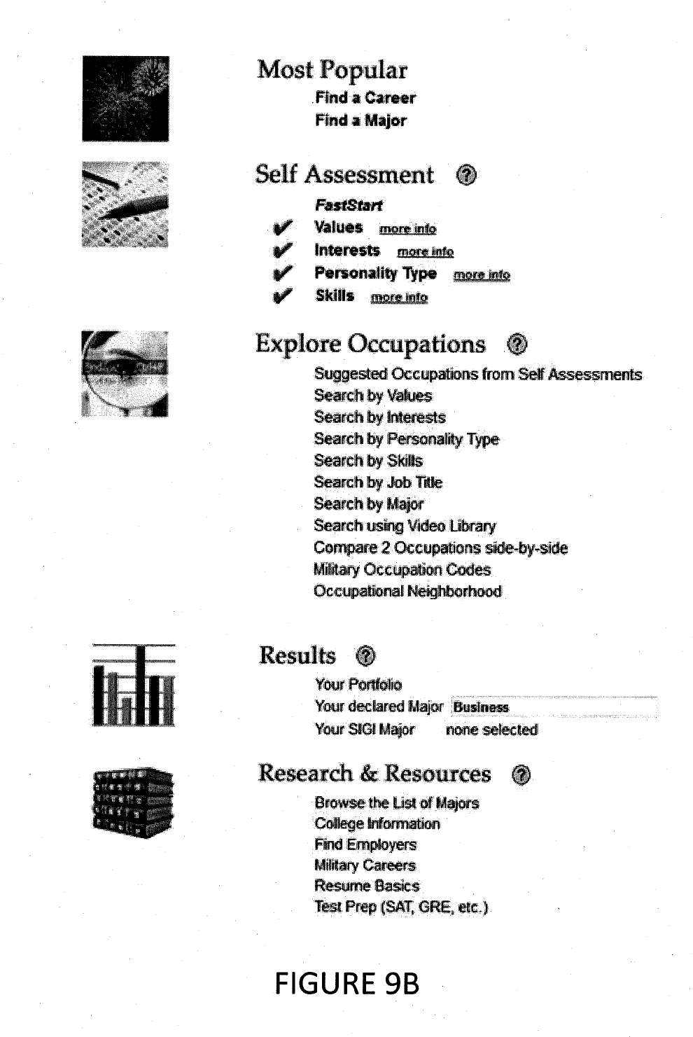

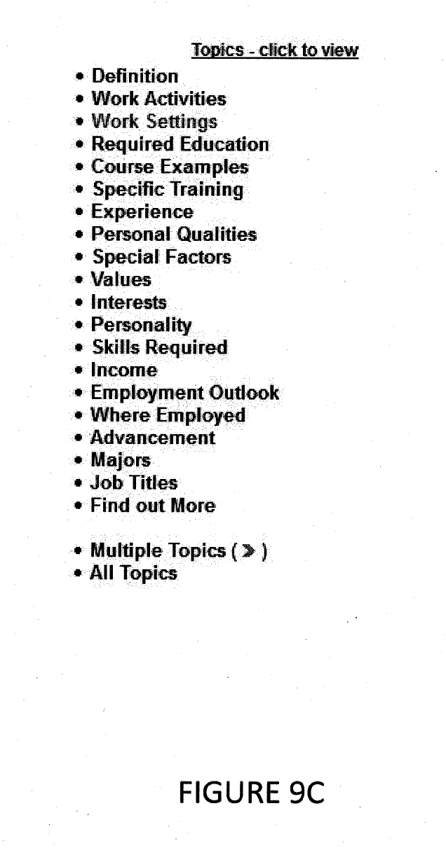

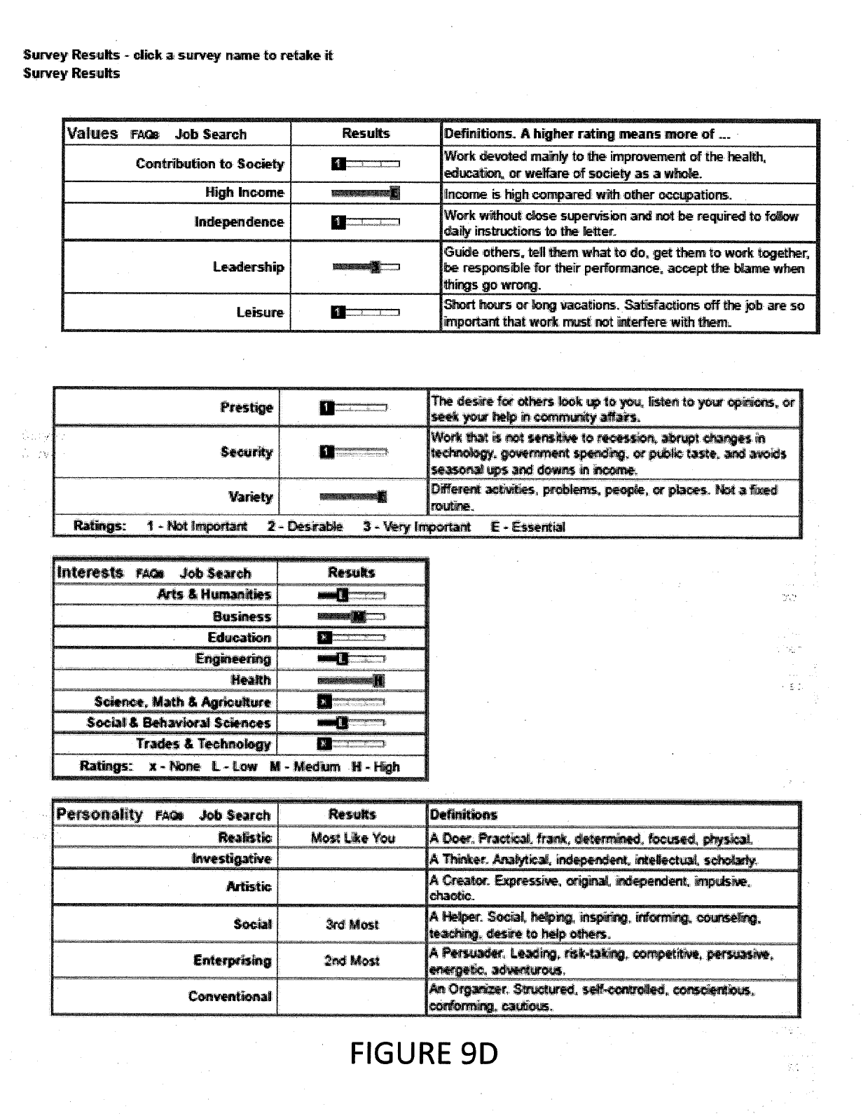

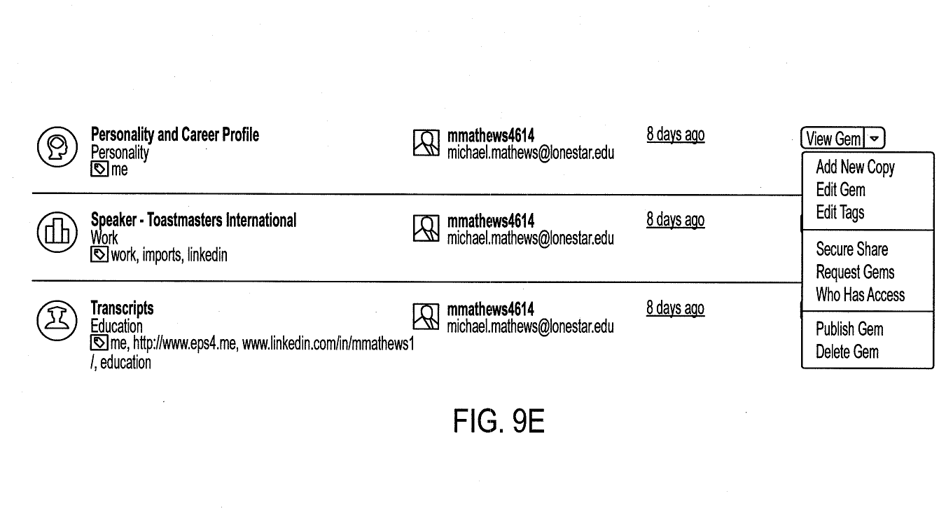

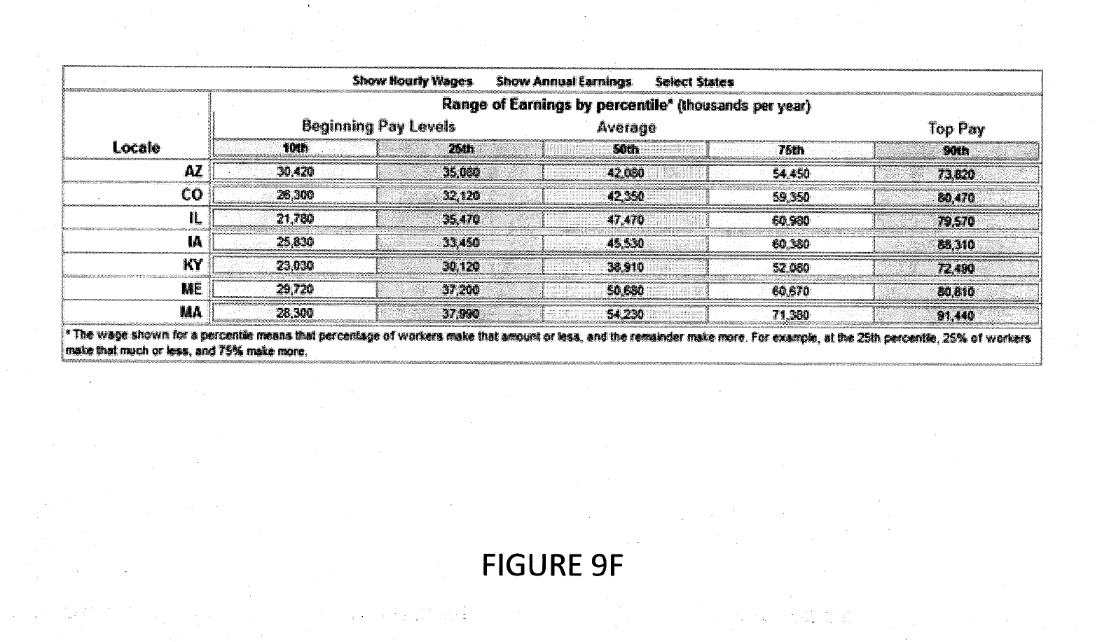

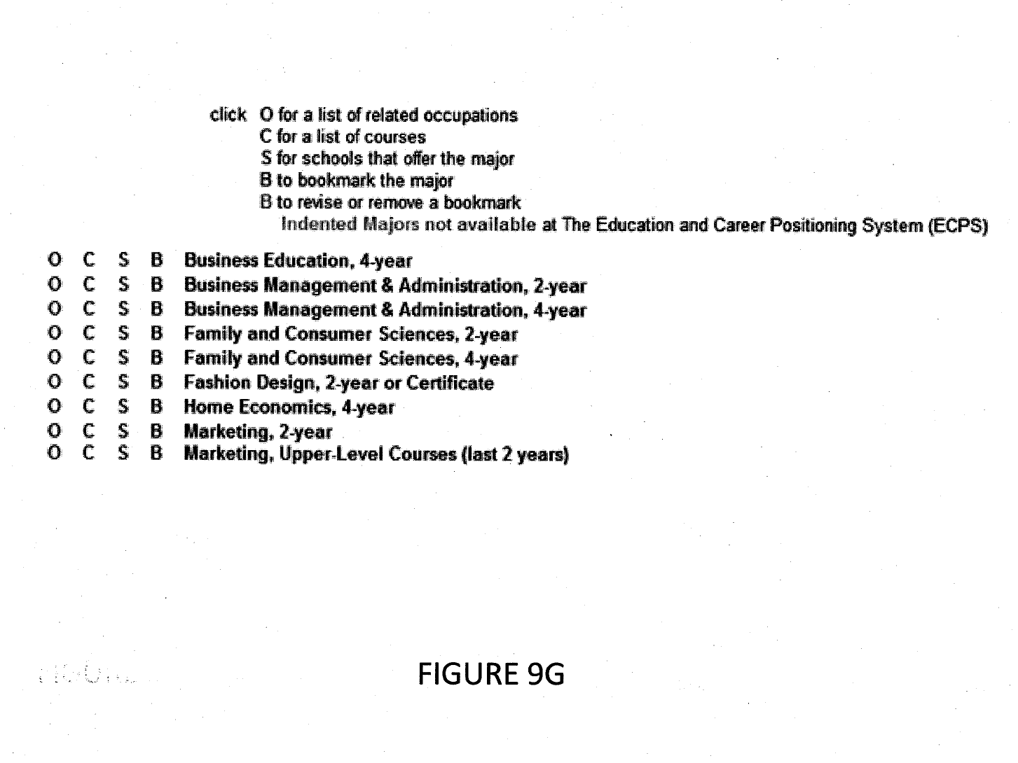

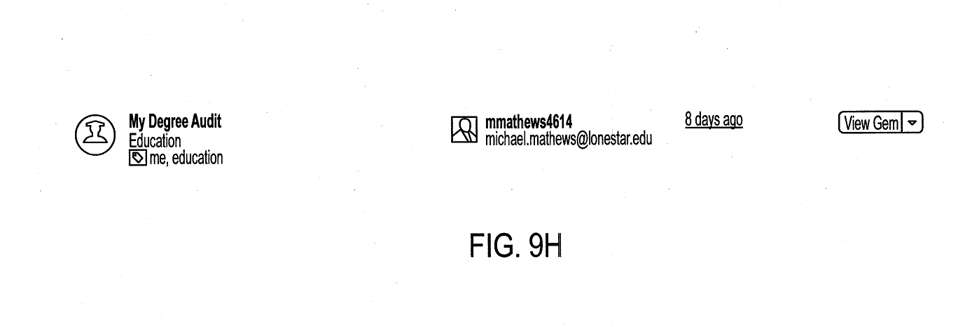

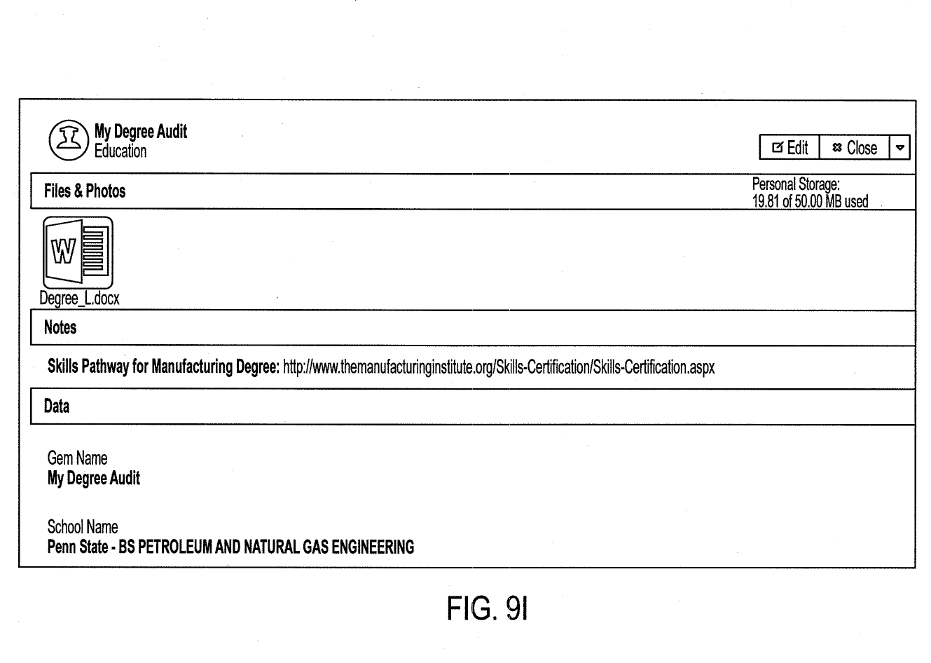

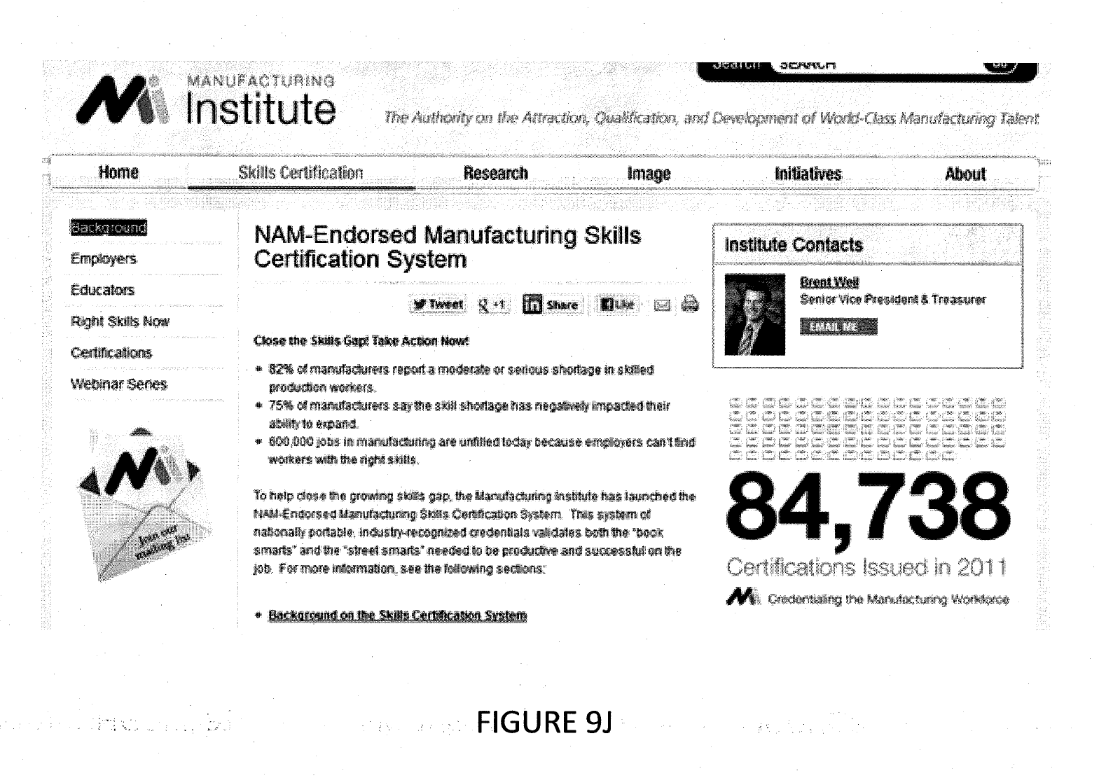

For example, users may able to view all courses, programs and schools from the ECPS Career2Simulation function set and validate the information against their values, abilities, persons, ad skills. FIG. 9B shows the complete ECPS selections for users who desire to match their interests, values, abilities, persons, ad skills against the right occupation.

A student may perform self-analysis to map against labor market and educational choices. The student completes a self- assessment by taking a survey provided by the system that shows the students values, interests, skills, and academic achievement. Based on the self-imposed survey the system automatically displays all careers, occupations, courses, majors, and programs that are the best fit for someone with like attributes. The student can compare these occupations and validate the choices, and retake the self-assessment survey as often as they like or feel they have changed. The ability to change and retake the survey due to owning the data and license allows the students to better align with the changes in the job market and their own improvements.

For example, a user may explore all types of careers and majors through clicking on the “Majors” and “Careers” selection. After exploring the careers and majors the student is able to fill out the ECPS “Fast Start” Survey and determine their skills, interests, values, and personality type. The survey uses commercial personality, interest, and skills-testing, such as commercial personality, interest, and skills-testing that has been developed by Valpar International, to validate the profile of the student. Upon completion of the profile the system scans the database of all available occupations for the top matches of occupations. The user can retake the survey and rebuild their profile as many times as they desire.

In block 420, job market information may be received. Job market information may be received from and/or stored in jobs database 230. Job market information may include local, regional, national, and international information; labor projections, including historic, present, future, and growth; salary data including percentile earnings, by state, and comparisons; and job traits, including one or more personal traits needed for jobs.

For example, system may report all occupation matches to a user. Upon selecting the matching occupations the student is able to review the entire inventory of characteristics for that occupation. FIG. 9C shows some or all the selections that the user can review to make sure that the career is truly a best-fit for them.

Once the student identifies their profile they are able to save their profile into their personal EPS vault (which may also be referred to as EDUVault or EPSVault) so they have continual and instant access to their profile. They can also allow others to view their personal profile by making their own decision on who can access or view their personal data. FIG. 9D shows a saved profile for a sample user, while FIG. 9E shows the image of the information and ability to share within the EPS vault. The EPS vault may securely store the user's information as personal “Gems” of information. The image illustrated in FIG. 9D may also be a PDF file underneath the Gem called Personality and Career Profile. The data presented in FIG. 9D may represent or be the exact data that was produced by the user who filled out the user profile survey.

Upon reviewing the best fit jobs the user can select the ‘Income’ link and see the wages in an annual salary or hourly basis. The user can select from any number of states of the United States, e.g. eight, and compare the wages from all eight states. FIG. 9F shows the income description. The wage and income information may be obtained from the Bureau of Labor Statistics. This information is pulled into the ECPS as it is updated from the Bureau of Labor Statics.

In block 430, a plurality of education pathways may be determined. Education pathways may include information relating to certifications, including pathways to certifications, required certifications, and optional certifications; examinations, including pathways to examinations, required examinations, and optional examinations; and education pathways, including degree level required, viable training institutions, viable colleges/universities, and applied military or work experiences requirements. Education pathways may be received from or stored in institution database 235.

For example, after the user has narrowed down their possible matching occupation they can choose to 1) Redo their profile and validate that their interests, skills, values, and personality and/or 2) they can review occupations that are related to the ones that have been selected. FIG. 9G shows the ‘O’ Link that can be selected to look and investigate more similar occupations.

In block 440, institution information may be received. The retrieved institution information may correspond to the educational choices received for a user, the educational pathways determined for a user, or any combination thereof. Institution information may also include financial, time, and location criteria associated with taking education pathways.

For example, once the user has narrowed down the best searched occupation for themself, they can start reviewing the courses, and schools that best offer the degree, major(s), and courses. The course, majors, and school selection may utilize a combination of websites available through the U.S. Department of Education to rate, rank and identify all U.S. Colleges and Universities.

In block 450, a best fit selection process may be applied to determine one or more of the plurality of educational institutions and one or more of the plurality of educational pathways. The best fit selection process may be accomplished when after selecting the best fit occupations, the user then selects the link for schools that offer the required programs and courses.

For example, assuming a user determines that they are a fit for a specific career and job in manufacturing, they will be able to access the skills pathway for all jobs relating to that career. For instance, the user who may be studying to be a chemical or petroleum engineer in the manufacturing field will be prompted with the link the “Stackable” credentials required by the national association of manufacturers, manufacturing institute. An example of the stackable credentials are illustrated in FIG. 9J. The access and analysis to the stackable credentials is a combination between the degree audit issued by the school and the pathway to full credentials as identified by the manufacturing institute. FIG. 9H shows the EPS vault that has “My Degree Audit” and FIG. 9I shows the word document or access to the word document containing my degree audit findings and the link to the stackable credentials

In block 460, one or more of the plurality of educational institutions and one or more of the plurality educational pathways may be presented. For example, the viewable school selections may leverage the College navigator and the College Score card that allows comparative analysis for the user. The best fit selection process maybe result in 3-5 best institutional choices based on location, scholarships, rankings, costs, graduation rates, and placement rates.

Any or all of blocks 410-460 may be repeated by users to update records, plan education and career journeys, and provide employers with verified reports of user qualifications. For example, any or all of blocks 410-460 may be repeated by users every time a user enters or completes a grade level during the user's complete academic career.

A user who follows the full process will be able to use the ECPS's EDUFAX to track how they align with careers and available jobs within their particular industry.

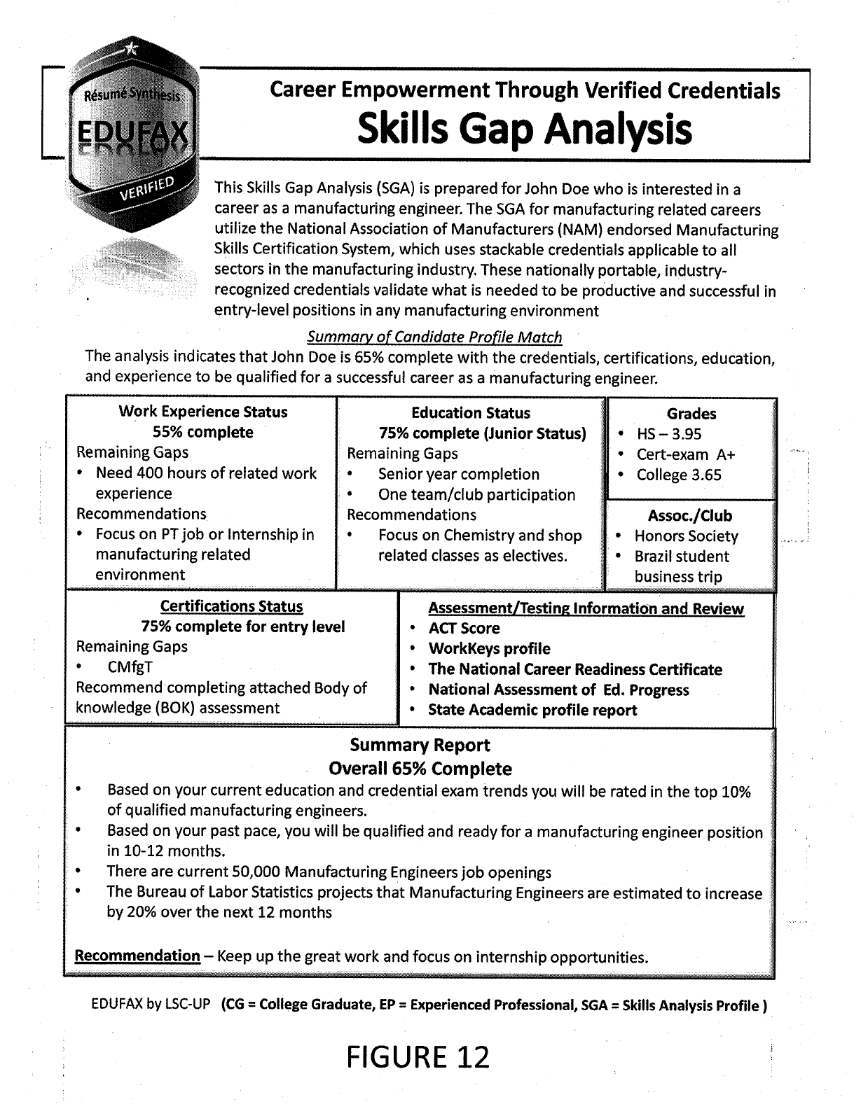

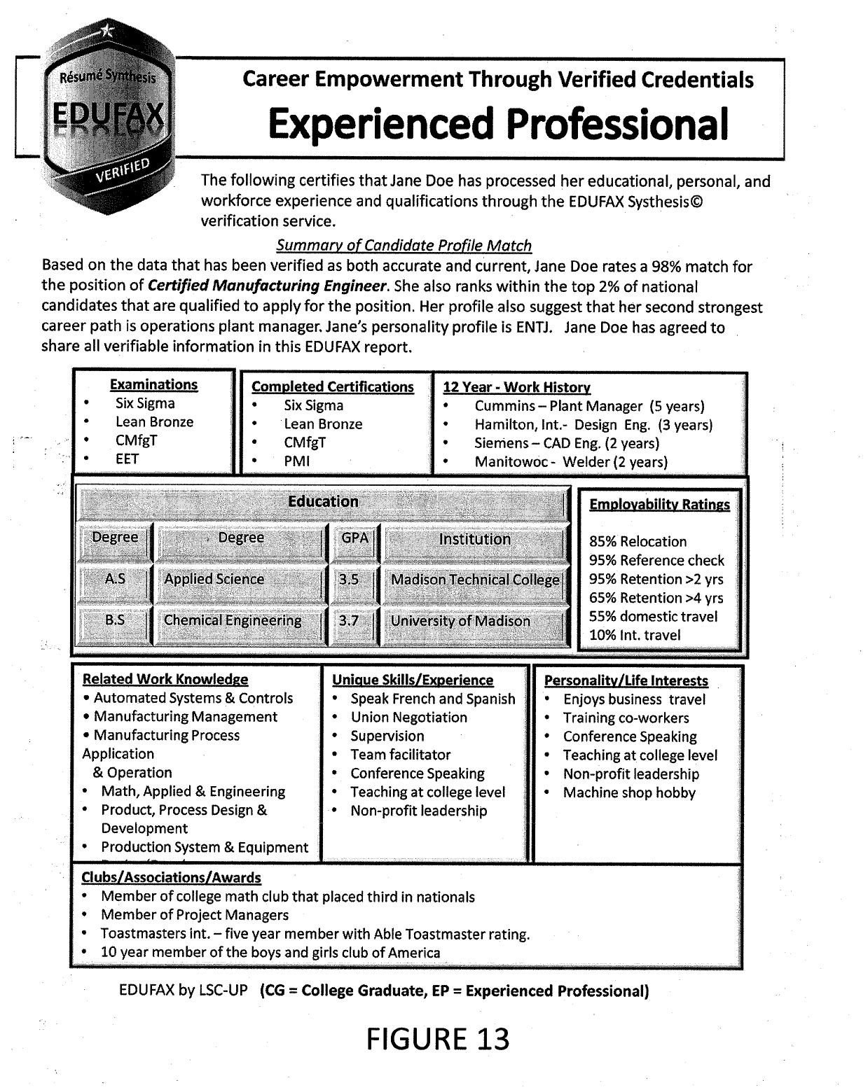

Using a manufacturing skills pathway as an example, user who are progressing through their education will be able to use the Skills-Gap Assessment version of the EDUFAX template show in FIG. 12. This template may be be self-populated by the user or auto-populated by the information from the personal EPSVault by ECPS. FIG. 11 illustrates an EDUFAX for a college graduate who stayed on the pathway to be qualified for the occupation and a specific job as a certified manufacturing engineer. FIG. 13 represents an EDUFAX for an experience worker who has taken the right certifications and examinations to be qualified as a certified manufacturing engineer. The EDUFAX may be populated by all the data located within the EPS vault and can be verified by three commercial vendors directly within the ECPS.

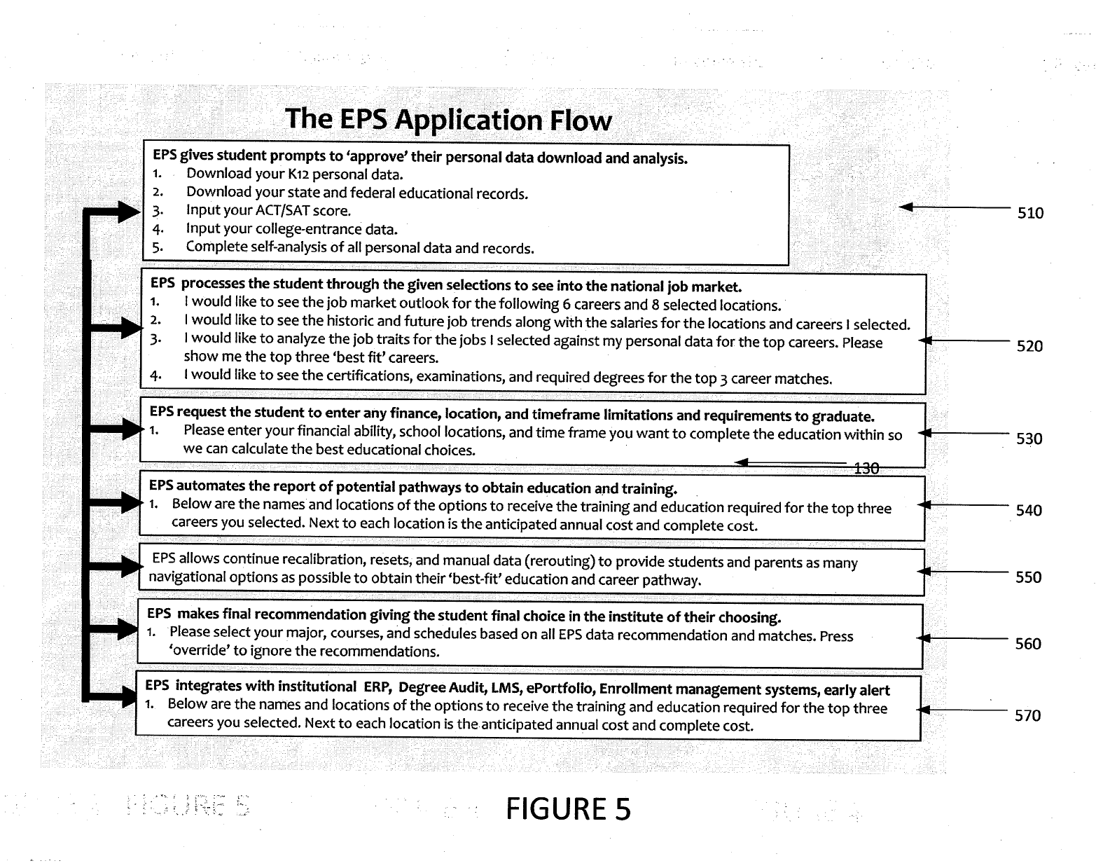

FIG. 5 depicts an exemplary application flow. FIG. 5 may be used to implement part of the method depicted in FIG. 4. In block 510, an interface may give the student prompts to approve their personal data download and analysis. For example, the user may be prompted to download K12 personal data, download state and federal education records, input an ACT, SAT, or other standardized score, input college-entrance data, and complete self-analysis of all personal data and records.

In block 520, the application may process the student through the given selections to see into the national job market. For example, the student may be given the options to see the job market outlook for user or system selected careers and locations; to see the historic and future job trends along with the salaries for the locations and the careers that the user selected; to analyze the job traits for the jobs the student selected against the student's persona data for top careers; to see a number of top “best fit” careers for the student; and to see the certifications, examinations, and required degrees for a number of top career matches.

In block 530, the application may request that the student enter any finance, location, and timeframe limitations and requirements to graduate. The user may be presented with and enter information responding to prompts for each of these pieces of information.

In block 540, the application may determine and generate a report of potential pathways to obtain education and training. For example, the student may be presented with names and locations of options to receive the training and education required for the top three careers selected. Next to each location may be presented the anticipated annual cost and a complete costs.

In block 550, the application may provide navigation options, such as recalibration, resetting, and rerouting to provide students and parents as many navigational options as possible to obtain their “best-fit” education and career pathways. For example, a student may go back to any of the previously displayed prompts and change answers in order have the application provide updated report.

In block 560, the application may provide a final recommendation of institute giving the student final choice in the institute of the student's choosing. The student may be presented with a prompt to select majors, courses, and schedules at the institution based on the collected data, the application's recommendations, and the application's matches. A user may select an option to override and to ignore the recommendations.

In block 570, the application may integrate with institutional ERP, Degree Audit, LMS, ePortfolio, enrollment management systems, and/or early alert systems. Using information retrieved from one or more of these or other sources, the application may present the user with the names and locations of the options to receive the training and education required for the top number of careers that the user selected. Next to each location, the anticipated annual cost and complete cost may be presented. The application may also produce a display or print-out of an EDUFAX of personal credentials via the EDUFAX Synthesis resume builder.

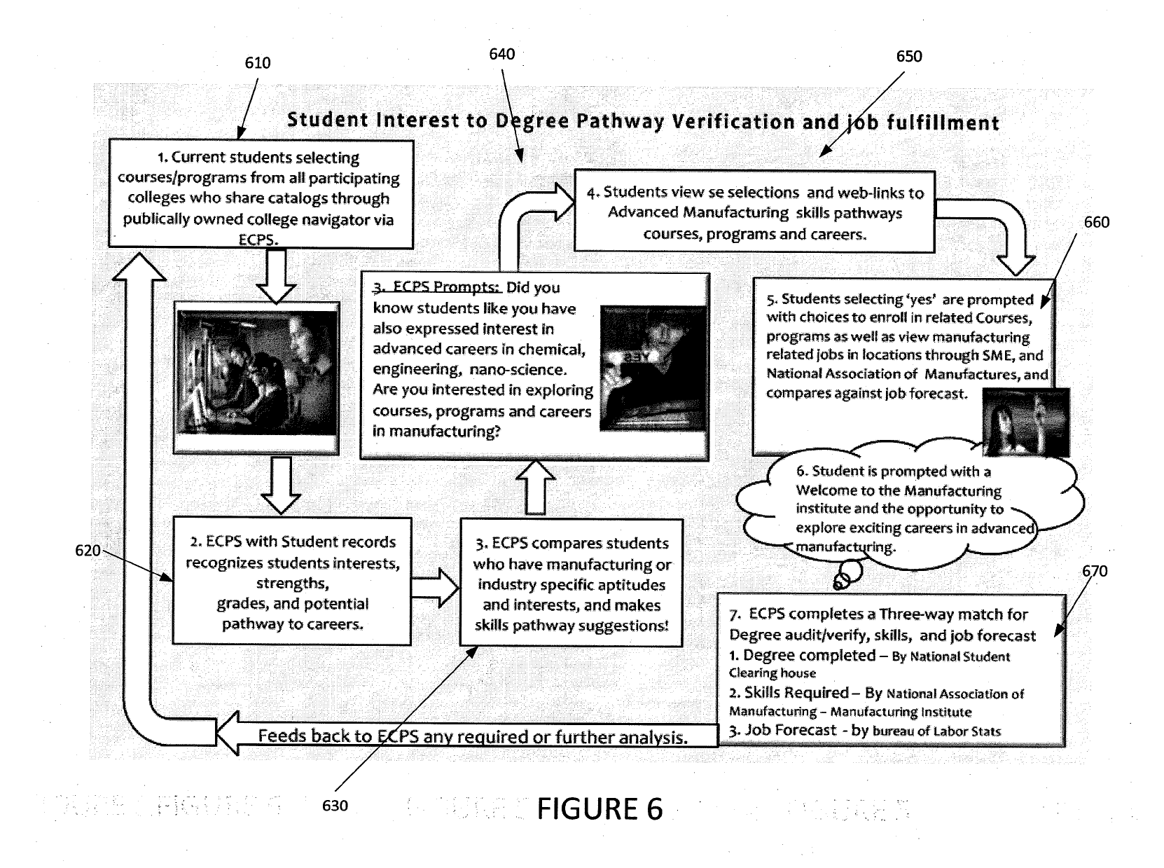

FIG. 6 depicts an exemplary workflow using the system 200 in accordance with one or more embodiments. In block 610, a student may select courses and/or programs from all participating colleges that share catalogs through the National Clearinghouse. In block 620, EPCS may recognize student interests, strengths, grades, and potential pathways to careers. In block 630, the EPSC may compare students who have manufacturing aptitudes and interests, and make profile suggestions. In block 640, the student may be prompted to explore particular courses, programs, or careers. In block 650, students may be presented with selections and web-links to advanced manufacturing courses, programs, and careers. In block 660, a student that selects ‘yes’ to selections in block 650 may be prompted with choices to enroll in related courses and programs, as well as view manufacturing related jobs in locations through SME and NAM. The student may also be presented job forecast and comparisons for the options presented. In block 670, EPCS may perform a three-way match for degree audit/verify, skills, and job forecast. Determining whether a degree has been completed may be performed using the National Student Clearinghouse. Determining the skills required for the position may be performed using information from the National Association of Manufacturing—Manufacturing Institute. Determining the job forecast may be performed by using information provided by the Bureau of Labor Statistics.

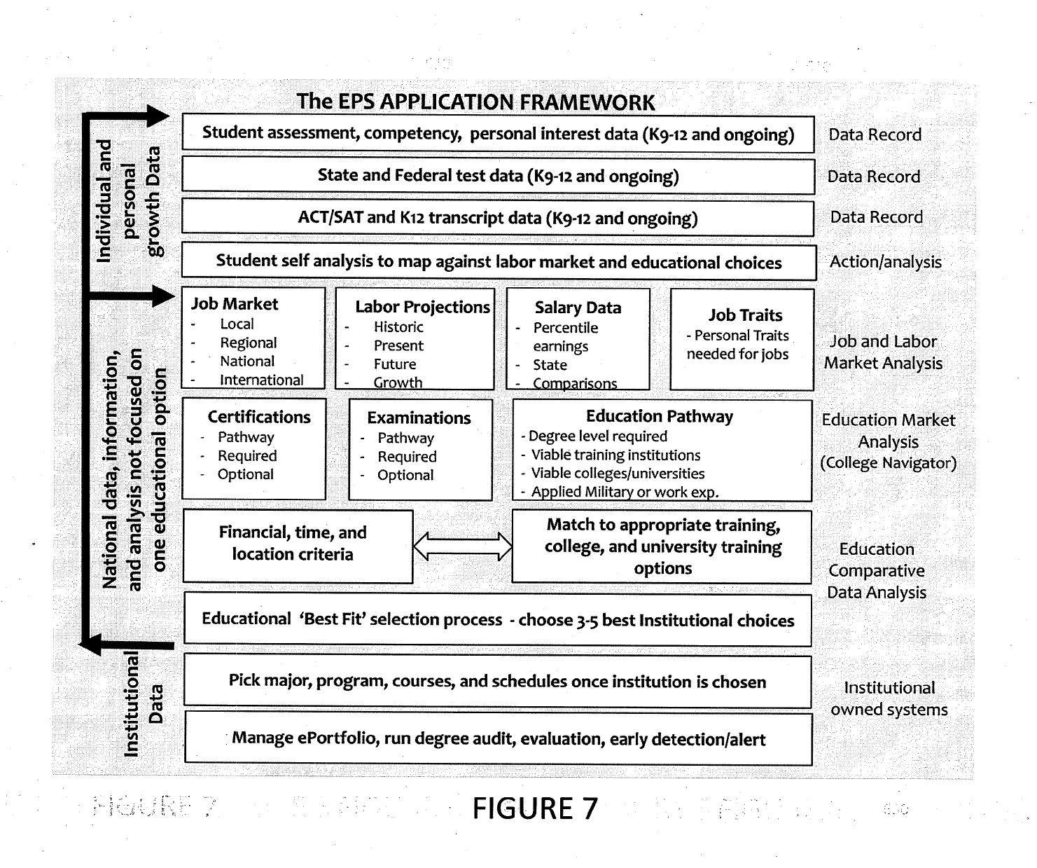

FIG. 7 depicts an exemplary application framework in which functions of the application may be broken across personal data, career data, and institutional data in accordance with one or more embodiments.

FIG. 8 depicts an exemplary user interface for presenting access to the different functions of the application in accordance with one or more embodiments.

FIG. 9A depicts an exemplary user interface and device for providing access to a user to an educational and career positioning system. FIGS. 9B-9J depict exemplary user interfaces for providing access to a user to an educational and career positioning system.

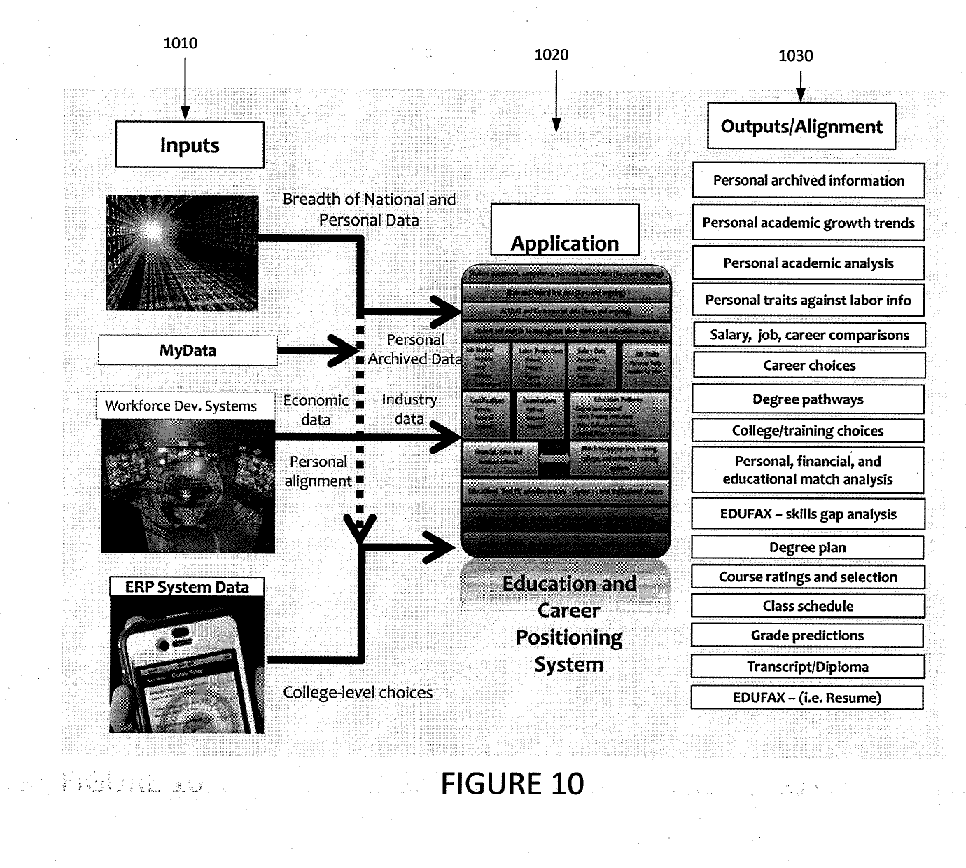

FIG. 10 depicts exemplary application inputs and outputs in accordance with one or more embodiments. Application 1020 may receive inputs 1010. Inputs 1010 may include information received from the MyData initiative, Workforce development systems, and ERP systems data. The information received from these sources may include national and personal data, personal archived data, economic data, personal alignment data, college-level choices, etc. The information received from these sources may also include other information inputs described herein.

Application 1020 may produce outputs 1030. Outputs 1030 may refer to any outputs provided by application 1020. Outputs 1030 may include personal archived information, personal academic growth trends, personal academic analysis, personal traits against labor info, salary, job, or career comparisons, career choices, degrees pathways, college/training choices, personal, financial, and educational match analysis, EDUFAX skills gap analysis, a degree plan, course ratings and selection, a class schedule, grade predictions, transcripts, diplomas, an EDUFAX resume, and other EDUFAX documents.

Application 1020 may implement the functionalities described in the discussion of FIG. 4 and/or FIG. 5. Application 1020 may be implemented on any of the computing devices depicted in FIG. 2 and FIG. 3. Application 1020 may include any or all of the modules depicted in FIG. 1.

FIG. 11 depicts an exemplary EDUFAX report 1100 in accordance with one or more embodiments. Report 1100 may be generated by EDUFAX synthesis 150. Report 1100 may report a candidate's performance and other metrics associated with a particular career or field. For example, report 1100 may include a target career, report details degree information, examinations, grades/GPA, employability ratings, related work knowledge, unique skills/experiences, personality/interests, clubs/associations, and awards. Report 1100 may be provided as a verified document by a verification service.

FIG. 12 depicts an exemplary EDUFAX report 1200 in accordance with one or more embodiments. Report 1200 may be generated by EDUFAX synthesis 150. Report 1200 may report a the areas in which a candidate may lack certain credentials, certifications, education, and experience to be fully qualified for a particular position. For example, report 1200 may include statuses for different credentials, certifications, education, and experience requirements for a certain position, match percentage, completion statuses for work experience, education status, and certifications status, testing/assessment information, and a summary. Report 1200 may be provided as a verified document by a verification service

FIG. 13 depicts an exemplary EDUFAX report 1300 in accordance with one or more embodiments. Report 1300 may be generated by EDUFAX synthesis 150. Report 1300 may report a candidate's performance and other metrics associated with a particular career or field. For example, report 1300 may include a target career, report details degree information, examinations, grades/GPA, employability ratings, related work knowledge, unique skills/experiences, personality/interests, clubs/associations, and awards. Report 1300 may be provided as a verified document by a verification service.

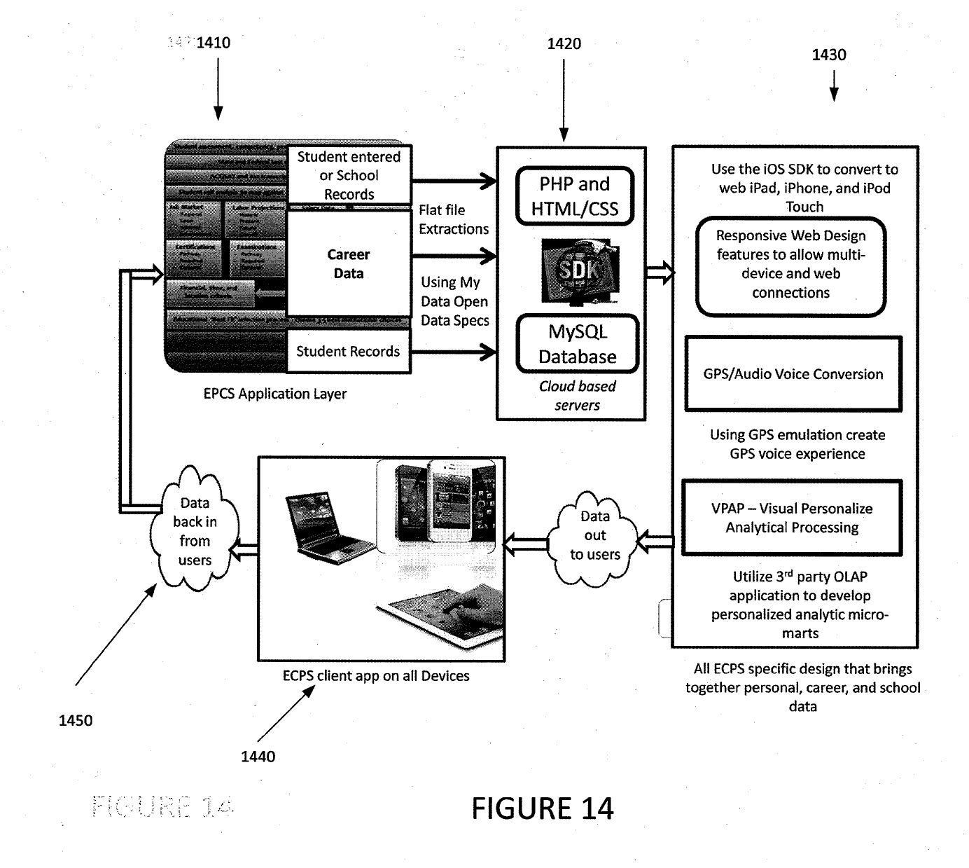

FIG. 14 depicts an exemplary educational and career positioning system in accordance with one or more embodiments. EPCS application layer 1410 may provide student entered or school records, career data, and student records to cloud based servers 1420. Application layer 1410 may provide the information through flat file extractions or by using My Data Open Data specifications. Cloud based servers 1420 may use web serving technologies, such as PHP, HTML/CSS, and MySQL database to produce device specific webpages 1430.

Device specific webpages 1430 may be created using an SDK, e.g., the iOS SDK to convert to web iPad, iPhone, and iPod Touch. Multi-device and web connections may be maintained. Device specific webpages 1430 may provide GPS-like audio voice conversation, in which the functions of a GPS are emulated when navigating options and/or career pathways. Device specific webpages 1430 may utilize visualize personalize analytical processing and may utilized OLAP applications to develop analytic micro-marts.

Device specific webpages 1430 may be viewed on one or more ECPS client applications 1440 on user devices. The user devices may capture data received from the users via the user devices and provide the data 1450 back to EPCS application layer 1410.

Although several of the exemplary embodiments have been discussed in the context of a student user and/or parent user, the users can be any type of user and are not limited to being students or parents.

### CONCLUSION

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. Thus, the breadth and scope of the present invention should not be limited by any of the above-described exemplary embodiments, but should instead be defined only in accordance with the claims and their equivalents.

1. A method comprising:
receiving, by a computing system, student information;
receiving, by the computing system, job market information;
determining, by the computing system, a plurality of educational pathways based on the student information and the job market information, wherein each of the plurality of educational pathways comprises a cost, a time, and one or more training mappings;
receiving, by the computing system, institution information corresponding to educational institutions;
applying, by the computing system, a best-fit selection process to determine one or more of the educational institutions and one or more of the plurality of educational pathways based on the plurality of educational pathways and the institution information; and
presenting by the computing system, the one or more of the educational institutions and the one or more of the plurality of educational pathways to a user.

2. The method of claim 1, wherein student information comprises student records, test information, one or more education goals, and one or more job goals.

3. The method of claim 1, wherein job market information comprises labor projections, salary data, one or more certifications, one or more examinations, and one or more jobs, wherein each of the one or more jobs correspond to one or more job traits.
